(19) United States
(12) Patent Application Publication
(10) Pub. No.: US 2011/0177980 A1
(43) Pub. Date: Jul. 21, 2011

(54) MICROFLUIDIC CHIP-BASED DNA COMPUTER

(76) Inventors: Bingcheng Lin, Dalian (CN); Bowel Li, Dalian (CN); Hua Xie, Dalian (CN); Jianhua Qin, Dalian (CN); Yisheng Zhu, Dalian (CN); Zhende Huang, Dalian (CN)

(21) Appl. No.: 11/759,048

(22) Filed: Jun. 6, 2007

(30) Foreign Application Priority Data
Dec. 6, 2004 (CN) 200410082858.3
Dec. 6, 2004 (CN) 200410082860.0
Dec. 8, 2004 (CN) 200410100842.0

(51) Int. Cl. C40B 60/08

(52) U.S. Cl. 506/37

(57) ABSTRACT

The present invention relates to computer science, molecular biology and microfluidics technique which provides a DNA molecular computer based on microfluidic chip. The objective is to provide a DNA molecular computer which uses the microfluidic chip as a operation platform, mainly including: using DNA molecules as operation media, using the microfluidic chip as the operation platform of a DNA molecular operator; using DNA molecules as storage media, using the microfluidic chip as the operation platform of a DNA molecular storage; using a electronic computer and a detector as the kernel of a controller; said microfluidic chip includes a DNA molecular computation region and a DNA molecular storage region. The microfluidic chip consists of digestion, ligation, PCR amplification and chip electrophoresis unit connected by microchannels in turn, and carries out the liquid control through micropumps and microvalves.

### BACKGROUND OF THE INVENTION

1. Field of Invention

This invention provides a Deoxyribonucleotide acids (DNA) computer with a microfluidic chip technology which carries out enzymatic reactions to cleave, ligate, and amplify DNA molecule on a microfuidic chip. Using the DNA molecule as an operation media, the genetic code before one reaction is taken as the input data, while the genetic code after the reaction is denoted as the operation results. A novel high speed DNA computer which possesses tremendous capacity is developed by performing various controllable DNA biochemical reactions followed by combining and integrating various chips in the DNA computer.

2. Description of the Related Art

DNA computer is an emerging field that basically combines molecular biological studies of DNA molecules and computational studies on how to employ these specific molecules to calculate. The main features of DNA computer are characterized by its high parallel computing ability, fast operational speed and enormous data storage capacity. However, the research on DNA computer until now has encountered the following two limitations. The first limitation is the lack of fully integrated hardware device that can support the biological operation-based computing, confirm the corresponding result and control the correlative parameters. The second limitation is that these molecular computing processes are carried out without registering or storing each computation processes. However, the storage function is one of the main features of modern computers which are also the essential character that differ a DNA computer from a DNA computing machine.

The microfluidic chip technology fully or basically integrates the fundamental operation units onto a chip with a size of about several square centimeters where the biological and chemical reactions such as sample preparation, enzymatic or chemical reactions, product separation and detection, etc. carry out. The availability of various operation units and the flexibility to combine them warrant the advantage of generating chips that can be integrated in large scale. Chip technologies, in principle, perform the reactions and the separation and detection of various types of molecules from nucleic acids and proteins to organic and small inorganic compounds.

In general, the chip technology includes two major categories. One is the array micro-porous board chip without circulating network and separation. This is usually called “biochip”, since it is relatively specific to DNA and protein. The other is based on microfluidic technology, with a network of microchannels on the chip and controllable liquid that runs through the whole system. This is usually called “Lab on a chip”, and is the mainstream of chip technology.

The development of microfluidic chip technology with high throughputs, integration and strong controllability provides a possible platform for substituting test tube or surface operation.

### BRIEF SUMMARY OF THE INVENTION

The objective of the present invention is to provide a DNA computer which uses the microfluidic chip as the operation platform. The invented DNA computer uses DNA molecules as operation or/and storage media while employing microfluidic chip as the operation platform of the DNA molecular computation or/and storage unit. An electronic computer and a detector are also supplied as the core of a controller.

The said microfluidic chip includes a DNA molecule computation area and a DNA molecule storage area. The microfluidic chip comprises the operation units for restriction enzyme-mediated DNA cleavage, ligase-mediated DNA ligation, polymerase chain reaction (PCR) and chip electrophoresis. These operations units are connected by microchannels in sequence with liquid control running through the micropumps and microvalves. The controller is connected to the electrodes of the microfluidic chips of the DNA molecule computation unit and the DNA molecule storage unit.

A unique aspect of this invention is the design of specific DNA sequences to be used in the computation or/and the transfer molecules as the operation media in a DNA molecule computation area. With such design, the output DNA molecule can represent computation results after the biochemical reactions were carried out by various enzymes. The biochemical reactions used in this invention include restriction enzyme-mediated DNA cleavage, ligase-mediated DNA ligation and PCR. Guided by the instruction of the said controller, various kinds of said biochemical enzymes were chosen and operated to complete the reactions on the microfuidic chip. The input part of said DNA molecule computation unit corresponds to the DNA computation molecule and/or DNA transfer molecule with specific sequence, while the output part corresponds to a DNA output molecule that represents computation results obtained through biochemical processes such as DNA cleavage and DNA ligation. A PCR amplification region is placed in front of the result output region in order to amplify the signal.

The DNA molecule storage area in this invention comprises of storage media, reaction media and the microfluidic chip. The said storage media includes a short-chain DNA molecule with a known sequence as a DNA blank molecule in an initial operation, and the DNA storage molecule that represents superposition results through biochemical reactions. The reaction media includes various kinds of biochemical enzymes used in DNA cleavage, DNA ligation and PCR. The microfluidic chip comprises of operation units of DNA cleavage, DNA ligation, PCR and chip electrophoresis, which are connected by microchannels in sequence with the liquid control running through the micropump and microvalve. Guided by instructions from the said controller, various said biochemical enzymatic reactions were carried out. The operation processes and the results were stored in said DNA molecule. The input part of said DNA storage molecule corresponds to the DNA blank and/or DNA storage molecule that contains a known sequence, while the output part corresponds to a DNA storage molecule after performing “superposition operations” obtained through biochemical processes of DNA cleavage, DNA ligation and so on.

The said detector in this invention performs detection of the DNA output molecule on the DNA molecule computation unit. Based on detected results, the said electronic computer sends commands to the DNA molecule computation unit and DNA molecule storage unit. These commands further enable the DNA molecule operation unit and DNA molecule storage unit to complete the whole reaction processes. Said detector can be a laser induced fluorescence detector, an electrochemical detector or an ultraviolet detector.

Sections for storing all kinds of operation media and reaction media are designed on said microfluidic chip. These sections are connected to each corresponding enzymatic reaction region through microchannels. Regions for storing buffer solution and waste solution, respectively, in a unified manner on said microfluidic chip are also provided

The inventors of this invention use the existing facility to design and set up a DNA computer with a microfluidic chip, which comprises of a microfluidic chip, a microfluidic chip workstation and a kit for completing all kinds of enzymatic reactions. The microfluidic chip is obtained by the superposition of a flat A with groups of microchannels and various operation units integrated on one side and a sealed flat B. Flat A possesses groups of various microchannels and operation units. The width of the microchannel in the chip is 75 μm. The cross section of the microchannels is an inverse trapezoid or a rectangle. Channels are sealed between the two flats, with the inlet and outlet of the channels set up on flat A. Flat B is a cover plate.

The said microfluidic chip can be made of glass, quartz or plastic, wherein plastic chip includes PDMS chip, PMMA chip and PC chip.

The microfluidic workstation is a set of existing and common work systems for the microfluidic chip, which consists of the integrated chip electrophoresis platform, laser induced fluorescence detector, CCD detector, power supply and computer operating system. It serves the functions of power supply for the chip, signal collection, and hardware control of the DNA computer.

A series of biochemical reagents are needed, in order to make said DNA computer carrying out functions of input, output, computation and storage. A kit including a piece of microfluidic chip for DNA computer; a set of each of restriction endonuclease reagents, ligase reagents, and PCR reagents; a bottle of electrophoresis buffer solution; and a set of standard DNA fragments are also included in this invention.

The restriction endonuclease reagents in this invention include restriction endonuclease and the reaction buffer solution. The restriction endonuclease belongs to the class of Fok I, Bgl I, BstX I, Sfi I and so on. The ligase reagents contain T4 DNA ligase and the reaction buffer solution. PCR reagents comprise Taq DNA polymerase, the reaction buffer solution and deoxyribonucleotide triphosphate (dNTP). A DNA marker with known length is used as the internal standard to determine the length of the DNA products.

Over all, this invention unprecedented adopts microfluidic chip technology to substitute currently used test tube or surface operation in the DNA computation process. The microfluidic chip technology described in this invention performs exact and controllable operations, and can be scaled up to integrate high flux. The invention provides a realistic and possible platform for constructing a DNA computer within the rigorous sense.

### BRIEF DESCRIPTION OF THE DRAWINGS

FIG. 1 is an illustration of system structure of the DNA computer based on microfluidic chip.

FIG. 2 shows a photograph of the microfluidic chip workstation of a DNA computer.

FIG. 3 is a schematic view of a microfluidic chip for a DNA computer. A. a surface plate integrating groups of various microchannels and the inlet/outlet. B. a cover plate.

FIG. 4 is a schematic view of the computation unit of a microfluidic chip-based DNA computer. The drawing shows: reservoir (1): a DNA cleavage reaction chamber; reservoir (2): a DNA ligation reaction chamber; reservoir (3): a PCR reaction chamber; reservoir (4): a buffer reservoir; reservoir (5): a standard DNA; reservoir (6): a waste reservoir; (7) and (8): a microvalve and a micropump, respectively, which controls the connectivity between each operation unit.

FIG. 5 is a schematic view of the storage unit of a microfluidic chip-based DNA computer. The drawing shows reservoir (9): storage unit molecule reservoir; reservoir (10): DNA cleavage and ligation reaction reservoir; reservoir (3): a PCR reaction chamber; reservoir (4): a buffer reservoir; reservoir (6): a waste solution reservoir; reservoir (12), a sample waste reservoir; (7) and (8) represent a microvalve and a micropump, respectively, which control the connectivity between each operation unit.

FIG. 6 is a schematic view of the kit used in DNA computer.

FIG. 7 shows the finite state automaton with two input symbols of (a, b) and three states of (S₀, S₁, S₂).

FIG. 8 shows the sentence structure of triangle.

FIG. 9 shows the calculating procedure and corresponding electropherograms of finite state automaton with the “aabbb” input symbol.

FIG. 10 shows the storing process of a microfluidic chip-based DNA computer and corresponding electropherograms.

### DETAILED DESCRIPTION OF THE PRESENT INVENTION

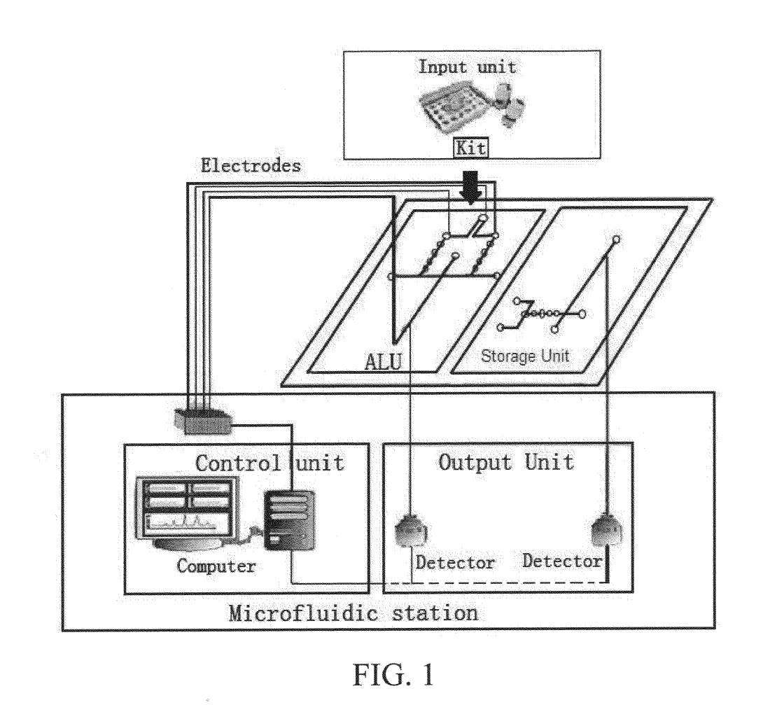

This invention presents a microfluidic chip-based DNA computer which comprises a microfluidic chip workstation, a microfluidic chip and a set of kits to hold all kinds of reagents for the enzymatic reactions (FIG. 1). The microfluidic chip workstation comprises of an electrical power, a control device and an output device, for the functions of power supply, signal collection, and concurrently administers the control of the DNA computer. The high voltage, direct electrical current of the workstation is connected to eight electrodes where different voltages, if needed, can be applied to different positions of the microfluidic chip to control the flow of the reaction solution among the channels according to demand. The detector of the microfluidic chip workstation can move correspondently to the chip to detect the reaction products in arithmetic logic unitblock and storage blockunit, respectively. The chip is the core of the whole computer. Both the operational computation function and the storage function of the computer are present on the chip. The DNA molecules and all kinds of reagents in the reagent boxkit enter the system through input blockunit.

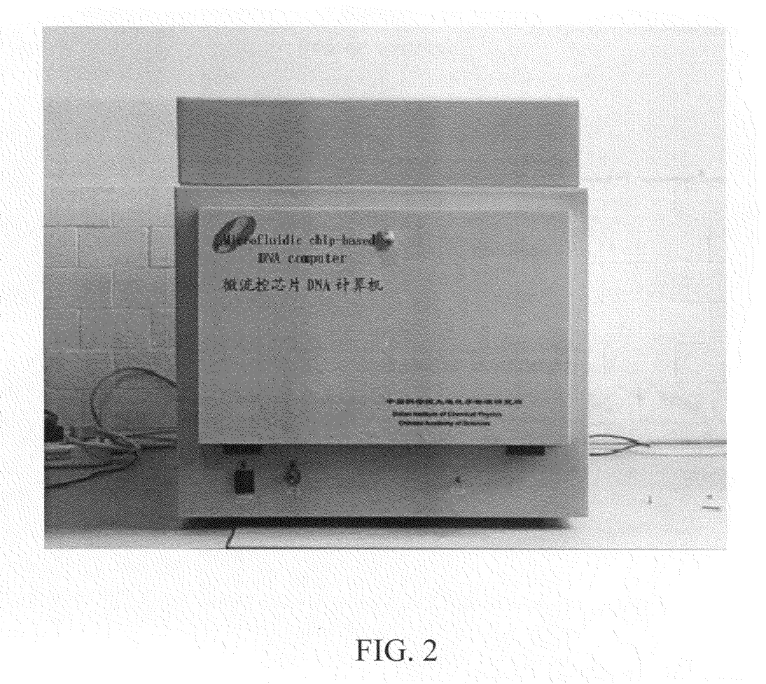

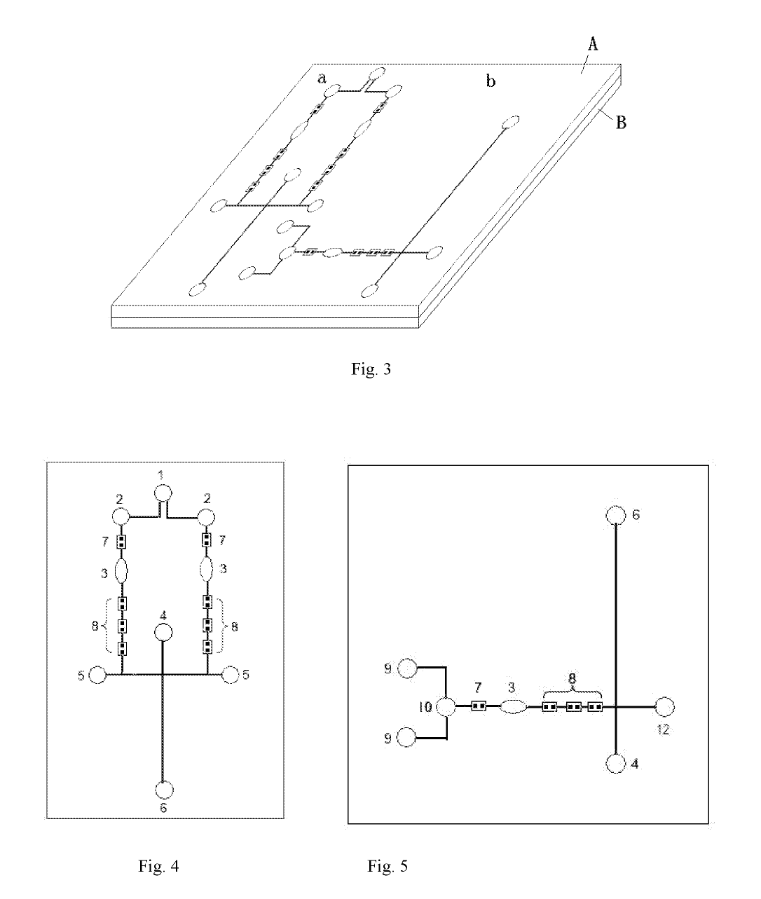

An existing device that shows the microfluidic chip workstation of integrated DNA computer was depicted in FIG. 2. It possesses two driving modes of electroosmosis and pressure, uses laser induced fluorescence as the detection means, and includes the laser induced fluorescence detection, CCD image supervision optical system, eight-electrode direct current high voltage power source and software system. The upper side of the microfluidic chip workstation is the chip's fixed platform and electrode operation platform which can move up and down. The down side comprises of integrative optical detection system, including CCD for focusing and channel supervision as well as the optical detection system. The region of narrowband filter is designed to be replaceable for multiple wavelength choices. The rearward of the workstation is comprised of switchable high voltage power source and related circuits. The hard core of DNA computer where groups of complicated microchannels are integrated—the microfluidic chip—was shown in FIG. 3. It prosecutes functions of input, output, computation and storage; integrates the operation units of DNA cleavage and ligation reaction, PCR and electrophoresis separation. The reservoirs and microchannels of Group (a) prosecute the input, output and the computational function of DNA computer while the reservoirs and microchannels of Group (b) complete the function for storage.

The computationarithmetic logical unit (a) is on left hand side of the chip, as shown in FIG. 3 (a) and detailed in FIG. 4. Reservoir (1) in FIG. 4 is the restriction endonuclease DNA cleavage reaction chamber. It also serves as the input unit of DNA computer for receiving all instructions. The restriction endonuclease DNA cleavage reaction chamber (1) is connected to two DNA ligation reaction chambers (2) and then two PCR chambers (3) in sequence. The buffer reservoir (4), the waste reservoir (6) and two standard DNA fragments reservoir (5) comprises a detection region of a cruciform channel. The injection channel is between the two standard DNA fragments reservoirs (5), and the detection channel is between the buffer reservoir (4) and the waste reservoir (6). (7) And (8) represent a microvalve and a micropump, respectively, which control the connectivity between each operation unit. PCR chambers (3) are connected to the injection channel of the detection region. The detection point is the fan-outoutput point. It detects the DNA molecule by laser induced fluorescence, transmits signals to the software of the workstation through ND transformation and then translates and expresses for output. The channels and reservoirs in the chip are necessary functional unit for finishing DNA computing, realizing biochemical reactions of the DNA, separating and detecting the reaction products in time, ensuring the input, output and completing the computational function of DNA computer.

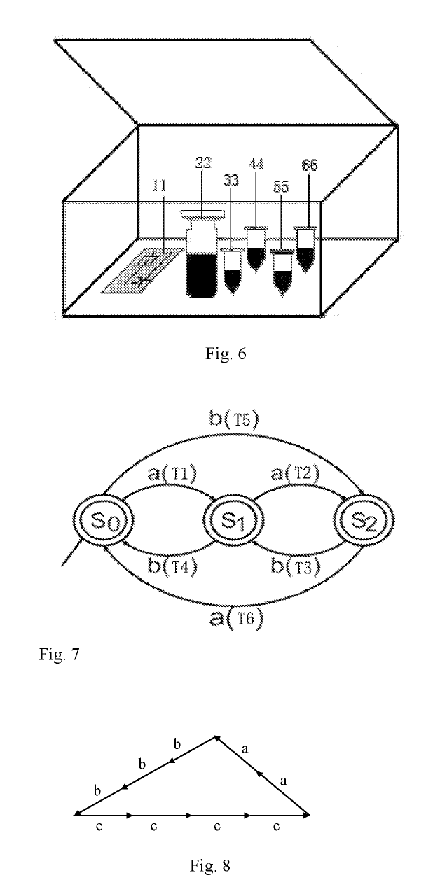

On the storage side of the chip, as shown in FIG. 3 (b) and FIG. 5, a “stack” storage is designed to store the results each computation step generate. This “stack” storage plays a relatively important role in identifying independent context. As shown in FIG. 5, the DNA storage unit comprises two storage unit molecule reservoirs (9), a DNA cleavage and DNA ligation reaction chamber (10), a PCR chamber (3), a buffer reservoir (4), a waste reservoir (6), a sample waste reservoir (12). The DNA cleavage and DNA ligation reaction chamber (10) is connected to two storage unit molecule reservoirs (9) and the PCR reaction chamber (3), respectively. The PCR chamber (3), the sample waste reservoir (12), the buffer reservoir (4) and the waste reservoir (6) form a detection region of a cruciform channel, while the detection channel is between the buffer reservoir (4) and the waste reservoir (6). The injection channel is between the PCR chamber (3) and the sample waste reservoir (12). (7) And (8) are the micro-valve and the micro-pump, respectively, which control the connectivity between each operation unit.

As shown in FIG. 6, the kits used in the microfluidic chip-based DNA computer_include a piece of microfluidic chip for DNA computer (11), a set of restriction endonuclease reagents (22), a set of ligase reagents (33), a set of PCR reagents (44), a bottle of electrophoresis buffer solution (55) and a set of standard DNA fragments (66). The restriction endonuclease reagents include restriction endonuclease and reaction buffer solution. The restriction endonuclease belongs to the class of FokI, BglI, BstXI, SfiI and so on. Ligase reagents contain T4 DNA ligase and reaction buffer solution. PCR reagents comprise Taq DNA polymerase, reaction buffer solution and deoxyribonucleotide triphosphate (dNTP). DNA marker with known length is used as the internal standard substance to determine the length of the DNA products.

This invention is unique as functions of each composition unit of the microfluidic chip-based DNA computer (shown in FIG. 1) are compared with those of the typical electronic computer. There differences are summarized in Table 1.

TABLE 1
the comparison between functions of each component in DNA computer and those of
the typical electronic computer

| | Input | Output | Operation | Memory | Control |
|---|---|---|---|---|---|
| Unit | Data input | Data display | Data processing | Data storing in | coherence and |
| | | | | the process of | harmony |
| | | | | operation | in all part |
| Electronic | Input equipment: | Output equipment: | ALU | EMS memory | CPU |
| computer | Keyboard, Mouse | CRT | | | |
| MC DNA | Specific DNA | A collection of | Various kinds | Memory chips | Control |
| Computer | molecule and | illustrative plates | of response | and the DNA | procedure |
| | corresponding | of the response | systems DNA | molecule | designed |
| | reagent in the react | molecule detected | computing | storing the | according to the |
| | chamberpool | by the work station | required | information | process of DNA |
| | | | | | computer |

The functions of the microfluidic chip-based DNA computer are described below:

For convenience, the finite state automaton with two input symbols of a, b and three states of S₀, S₁, S₂ is adopted to illustrate functions of the microfluidic chip-based DNA computer in FIG. 7. The finite state automaton is based on syntax pattern recognition of isosceles triangle.

In general, a triangle can be regarded as being composed of several line fragments of the same length, as shown in FIG. 8. Such line fragments are the fundamental components of a triangle, which includes horizontal line, ascending oblique line and descending oblique line. Therefore, a triangle represents character strings made up of units. For instance, the triangle illustrated in FIG. 8 can be expressed as “aabbbcccc”. In this invention, final state was obtained by DNA computation based on the above-mentioned finite state automaton. Comparison was then made between the two sides of the object. If the final state is S₀, both sides of the triangle are equal, and vise versa.

The formula for corresponding state transfer of the finite state automaton in FIG. 7 is designed as:

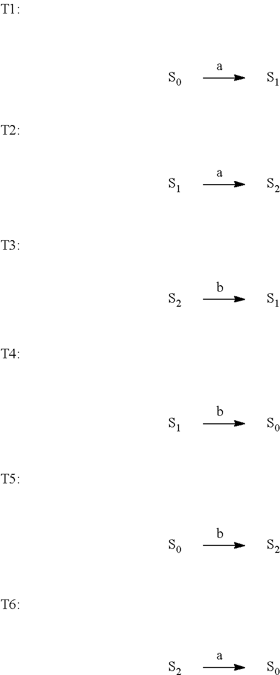

The transfer molecules are designed as:

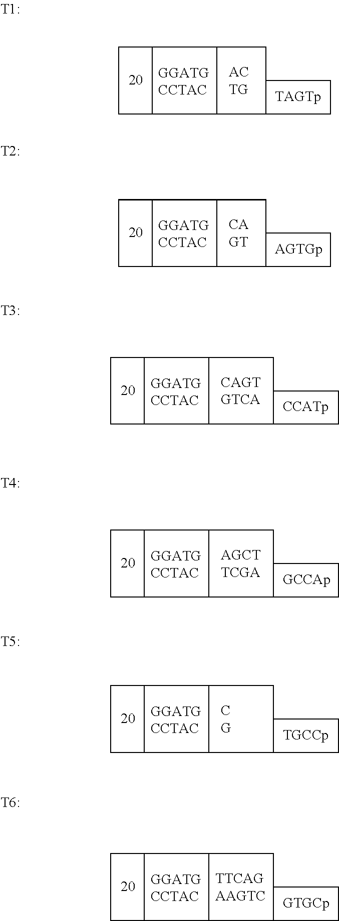

The twenty (20) base pairs on the left of the transfer molecules are assembled into different sequences.

The blue print of the finite state automaton of the microfluidic chip for a DNA computer is depicted in FIG. 3, which illustrated the principle and the processes of functions of input, output, computation, control and storage.

For example, when DNA molecules and the corresponding reaction reagents are added into the enzymatic cleavage reaction reservoir (1) in FIG. 4 as input data:
\textcircled{1}. The DNA molecule completes DNA cleavage, DNA ligation, and PCR in reservoirs (1)-(3) respectively, and carries out the DNA computing.
\textcircled{2}. Electrophoresis separation is carried out in the channels between reservoir (4) and reservoir (6). Then the data is exported.
\textcircled{3}. According to the exported data, the storage unit shown in FIG. 5 performs data storage.
\textcircled{4}. Various storage unit molecules are put into reservoir (9) in FIG. 5. DNA cleavage and ligation reaction, as well as PCR are completed in reservoir (10) and reservoir (3), respectively, to perform storage.
\textcircled{5}. The reaction products is separated and detected in the channels between reservoir (4) and reservoir (6). The storage results were recorded.

A detailed description of how to perform the five major functions of DNA computer in the finite state automaton on the microfluidic chip is shown below:

### (1) Input

Symbols of the input molecules in the finite state automaton in FIG. 7 are as follow:

| | | | |
|---|---|---|---|
| a: | ATCACG | b: | ACGGTA |
| | TAGTGC | | TGCCAT |

Terminator Molecule:

GTACCT
CATGGA

For example, if the finite state automaton with the initial state of “S₀” and input symbol of “aabbb”, the corresponding DNA input molecule is obtained as the following:

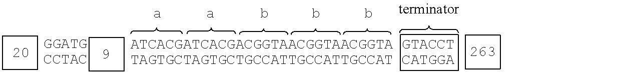

The solution containing the above-mentioned DNA sequence is guided into the reservoir (1) of the chip on the computing computation unit (Group (a) side a in FIG. 3) and the input process is performed.

### (2) Output

The restriction endonuclease of FokI is chosen. Its recognition site is 5′ . . . GGATG(N)₉▾ . . . 3′ and the enzymatic cleavage site is located at the end of 9^{th} nucleotide. After enzymatic cleavage, a 4 bp sticky end (the 9^{th} to 13^{th} nucleotide on the 5′ end of the opposite strand) is formed with its sequences vary according to the combination of different states and symbols. Table 2 depicts such a combination.

TABLE 2
The combination of different states and symbols

| Symbol | a | b | terminator(t) |
|---|---|---|---|
| Codings & <state, symbol> Sticky ends | 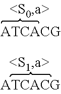 | 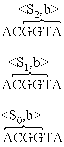 | 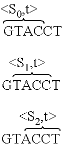 |

Each sticky end formed by enzymatic cleavage is ligated to a transition molecule with a complementary sticky end of the enzymatic reaction carried out by T4 DNA ligase.

The output-detecting molecule is designed to detect the corresponding states resulted from detecting program. Thus, the finite state automaton of each terminator state is designated to a corresponding output-detecting molecule as follows:

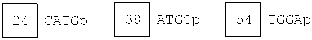

The output-detecting molecules and output-molecules joined together to form a report molecule which is detected and recorded in reservoirs (4)˜(6) on the chip, as shown in FIG. 4.

### (3) Computation

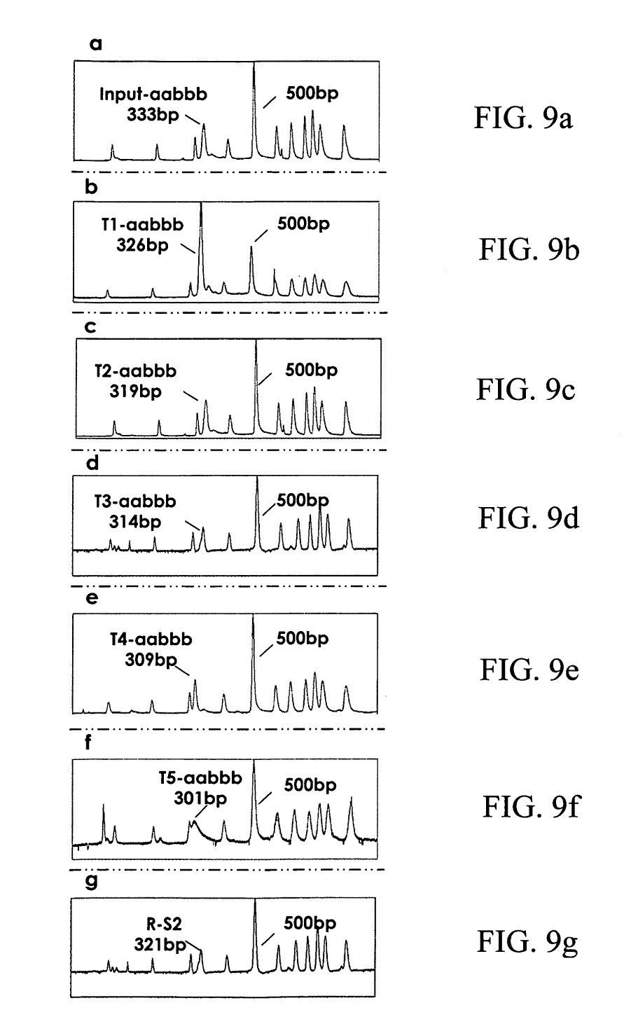

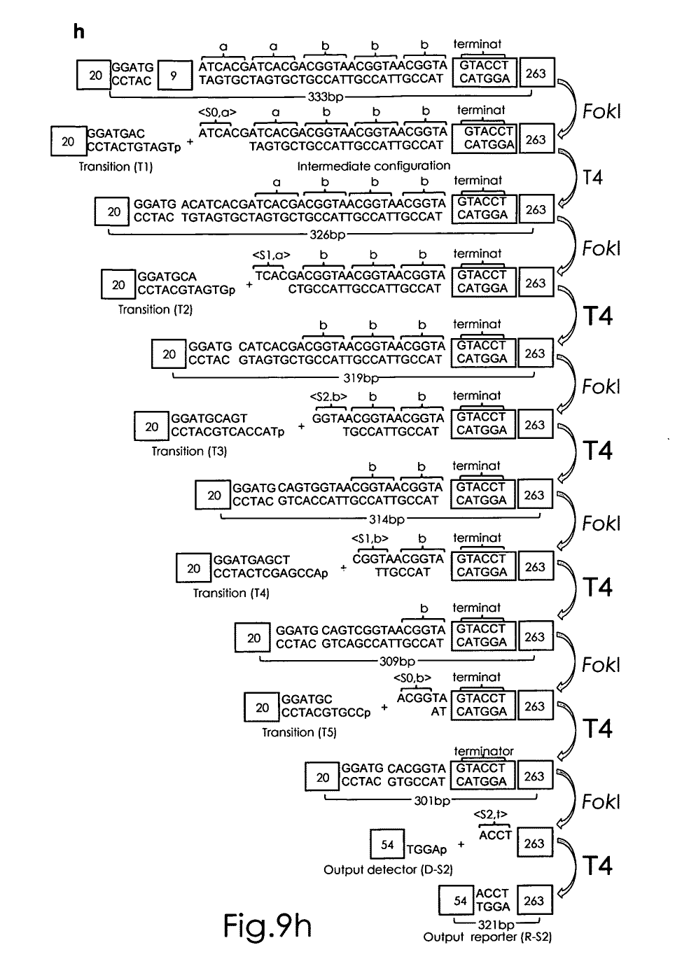

The calculating computational procedure and corresponding electropherograms of finite state automaton with an “aabbb” input symbol was shown in FIG. 9. In FIG. 9, (a)-(g) designate the corresponding electropherograms of input state, each intermediate state and output state. FIG. 9 (h) On the right hand side is the DNA sequential diagrams to show the computing procedure for the “aabbb” input symbol. FIG. 9 (a) is the electropherogram of the input molecule “aabbb”. FIG. 9 (b)-(f) show electropherograms of the intermediate resulting molecules generated during the computational process. FIG. 9 (g) is the electropherogram of output molecule. We identify the length of every specific DNA molecule (labeled as Input-aabbb, T1-aabbb, T2-aabbb, etc.) with 100 bp series marker as the internal marker. The peaks of the 100 bp ladder (with increasing migration time) represent the DNA molecules with 100, 200, 300, 400, 500, 600, 700, 800, 900, 1000, 1500 bp in length, respectively. The 500 bp peak in the ladder is significantly higher than others, thus it is used as a marker in the electropherograms. The peak of all specific molecules of FIG. 3 9 (a)-(g) had obviously changed their positions relatively to the peaks of marker, indicating the length of the DNA molecule has changed after enzymatic digestion and ligation.

### (4) Storage

The storage is completed by the data structure of “stack” in the microfluidic chip-based DNA computer. According to the computational results shown by the transfer molecule and the corresponding symbol, the microfluidic chip workstation controls the storage chip to record the corresponding data into memory molecules, and executes the storage function.

### (5) Control

The results of computation are fed back to the workstation. A pre-designed computer program controls the storage unit on the right hand side of the chip which stores the corresponding data in memory molecules. The sequences of the events are depicted as follows:
the signal that reflects the information of DNA molecule is sampled into the MC workstation via an A/D converter;
the sampled signal data are converted into graphic file;
the migration time of a DNA molecule required to migrate is proportional to its length. Therefore, the length of the PCR product can be calculated by analyzing the electropherogram of the PCR product mixing with DNA markers in a computer program. The transition molecules in each reaction are identified by the position of the peaks;
the result is displayed and a signal is sent to the data-storing endstorage unit of the DNA computer. The data information of each reaction step is stored via DNA molecules;
the computing computation unit of microfluidic chip on FIG. 1, side Group (a) transmit the signals to the workstation which subsequently connect and control the storage unit on side Group (b) (FIG. 1) until all orders are sent.

One of the biggest challenges in the field of DNA computing up to now is to build storing storage units that are capable of storing all the intermediate states and results of the calculation. This obstacle is unlikely to be resolved by conventional in-test-tube protocols. On other hand, our microfluidic chip technology is capable of solving this problem.

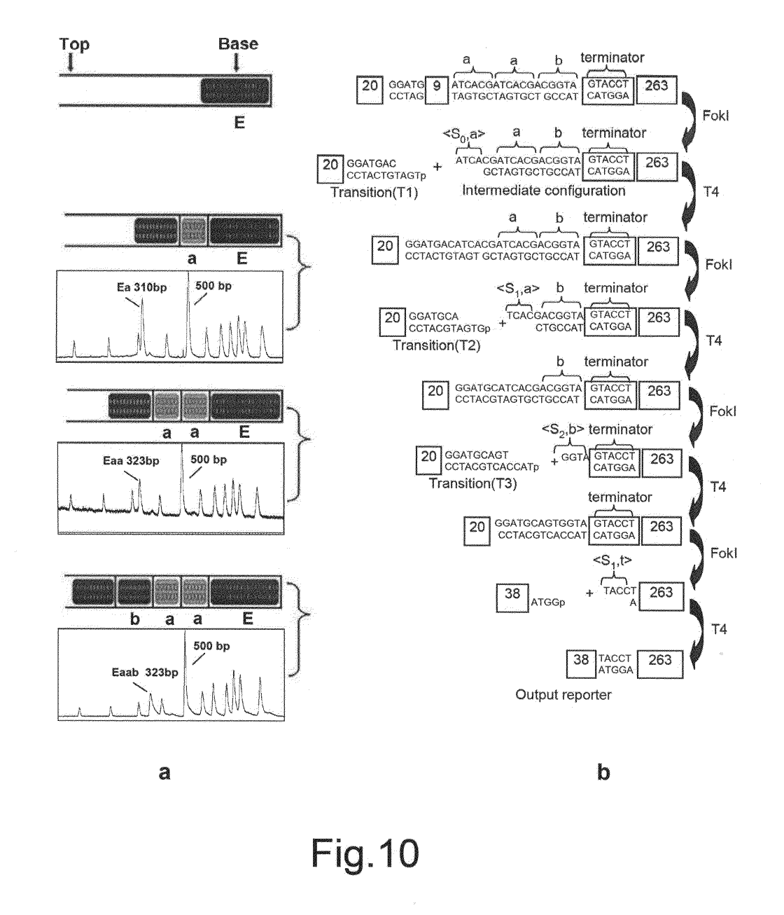

In detail, data structures like table, stack and queue are of vital importance to DNA computers as well as to conventional computers. Inputting symbol of “aab” is used as an example to illustrate how to generate the stack storing on microfluidic chip. We assume that the initial state of the storage unit is “empty (E)” (see FIG. 10), in other words, the bottom of the stack is filled with “E”. As mentioned before, Memory-a or Memory-b adds a 13 by or 21 by sequence, respectively, to the blank molecule “E”. The results of the storage could be obtained via the length or sequence detected at the end.

Molecule E was designed by amplifying the plasmid PUC 19 (TaKaRa Biotechnology Co., Ltd) with primer L1 and R1 which results in a DNA fragment of 304 bp. This DNA fragment, at the location of 417-422 (based on PUC 19 sequences), contains the recognition site of restriction endonuclease BamHI: GGATCC. A sticky end on its left hand side of the E molecule is obtained by BamHI cleavage of the DNA molecule.

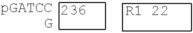

To design the storage unit molecule in the stack, the sticky end on the right hand side of Memory-a and Memory-b molecules will be annealed with the sticky end of the blank molecule “E” after BamHI cleavage first. The intermediate products will then be cleaved by FokI again because they comprise the recognition site of FokI. Storage is based on the state and the symbol of the transition molecule encoded. As mentioned before, Memory-a or Memory-b adds a 13 by or 21 bp, respectively, to the blank molecule “E” until the output of the terminator molecule. The results of the storage could be obtained via the length or sequence detected at the end.

A detailed operation process of storage is described as follows:

Firstly, the E molecule with a sticky end on its left hand side is obtained by the restriction endonuclease BamHI cleavage of DNA molecule at 30° C. in chamber (10) (FIG. 5). The length of the E molecule is detected to be 263 bp. The temperature is then raised to 65° C. for 10 min to deactivate BamHI. Memory-a or Memory-b is introduced into chamber (9) (FIG. 5) according to the result of calculating, which will then ligate with E molecule at 18° C. for 30 min. The ligase is then deactivated at 65° C. for 10 min. The DNA product after ligation is used as a template for PCR amplification, and the product is detected by electrophoresis. The above-mentioned processes are repeated until the output of terminator molecule, which signals the completion of storage. The final storage molecule encodes the information of DNA computing, which can be read out at any time.

Using “aab” input symbol as an example, the dynamic storage process of the finite state automaton is described as follows. The schematic view of the stack storage process and the corresponding electropherograms of the product of each storage step are depicted in FIG. 10 (on the left hand sidea). The corresponding computational process was shown on FIG. 10 on the right hand side(b). The transfer molecule contains the information of states and symbols during the computational processes. The transition molecules employed in the finite state automaton with the input symbol of “aab” are T1, T2, and T3. Their corresponding symbols are “a”, “a” and “b”. Memory-a and Memory-b molecules are joining to E molecule sequentially, forming Ea, Eaa and Eaab and achieving stack storage of input “aab”. Methods similar to stack storing process can also be utilized to achieve dynamic storing processes of table and queue.

What is claimed is:

1. A microfluidic chip-based DNA computer mainly comprising: using a DNA molecule as an operation media, using the microfluidic chip as the operation platform of a DNA molecular computation unit; using DNA molecule as a storage media, using the microfluidic chip as the operation platform of a DNA molecular storage; using an electronic computer and a detector as the kernel of a controller; mentioned microfluidic chip includes a DNA molecular computation area and a DNA molecular storage area. The microfluidic chip is comprised of operation units of enzyme cleavage, enzyme ligation, PCR and chip electrophoresis, which are connected by microchannels in sequence, and carry out the liquid control through a series of micropump and a microvalve. The controller is connected to the electrodes of the microfluidic chips of the DNA molecular computation unit and the DNA molecular storage unit respectively.

2. The of claim 1 wherein mentioned DNA molecule as the operation media completes the DNA molecular operation on the microfluidic chip of above-mentioned DNA molecular computation unit according to the instructions issued from above-mentioned controller.

3. The microfluidic chip-based DNA computer of claim 2 wherein: the input part of above-mentioned DNA molecular computation unit corresponds to the DNA computation molecule with specific sequence and the DNA transfer molecule with specific sequence, while the output part corresponds to a DNA output molecule that represents computation results obtained through biochemical processes of enzyme cleavage, enzyme ligation and so on.

4. The microfluidic chip-based DNA computer of claim 1 wherein mentioned DNA molecule as the storage media stores mentioned DNA molecular operation processes and results on the microfluidic chip of mentioned DNA molecular storage according to the instructions issued from mentioned controller.

5. The microfluidic chip-based DNA computer of claim 4 wherein: the input part of mentioned DNA molecular storage corresponds to the blank DNA molecule and DNA storage unit molecule that contains a known sequence, while the output part corresponds to a DNA storage molecule having undergone “superposition operations” obtained through biochemical processes of enzyme cleavage, enzyme ligation etc.

6. The microfluidic chip-based DNA computer of claim 1 wherein: mentioned detector performs detection aiming at the DNA output molecule of the DNA molecular computation unit and mentioned electronic computer issues commands to the DNA molecular computation unit and DNA molecular storage with identification and judgment based on the detection results, making DNA molecule complete the DNA molecular operation and DNA molecular storage on the operation platform of the microfluidic chips of computation unit and storage unit respectively.

7. The microfluidic chip-based DNA computer of claim 6 wherein mentioned detector can be a laser induced fluorescence detector, an electrochemical detector or an ultraviolet detector.

8. A microfluidic chip-based DNA molecular computation unit of mentioned microfluidic chip-based DNA computer of claim 1 comprising operation media, reaction media and the microfluidic chip: mentioned operation media is the DNA computation molecule with specific sequence, the DNA transfer molecule with specific sequence used in middle operation and the DNA output molecule that represents computation results through biochemical reactions; mentioned reaction media is the various kinds of biochemical enzymes used in enzyme cleavage and enzyme ligation reactions; mentioned microfluidic chip has at least enzyme cleavage reaction area, enzyme ligation reaction area, and result output area connected by microchannels in sequence, and carries out the liquid control through the micropump and microvalve.

9. The Microfluidic chip-based DNA computer of claim 8 wherein on mentioned microfluidic chip, the amount of enzyme ligation reaction sections correspond to that of the types of transfer molecules in the DNA molecular computation unit.

10. The DNA molecular computation unit with a microfluidic chip of claim 8 or 9 wherein on mentioned microfluidic chip, a PCR amplification region is disposed before the result output region.

11. The DNA molecular computation unit with a microfluidic chip of claim 8 or 9 wherein on mentioned microfluidic chip, there are sections for storing all kinds of operation media and reaction media and these sections are connected to each correlative enzyme cleavage reaction area or enzyme ligation reaction area through microchannels.

12. The DNA molecular computation unit with a microfluidic chip of claim 11 wherein on mentioned microfluidic chip, there are sections for storing all kinds of operation media and reaction media and these sections are connected to each correlative enzyme cleavage reaction area or enzyme ligation reaction area through microchannels.

13. The DNA molecular computation unit with a microfluidic chip of claim 8 or 9 wherein on mentioned microfluidic chip, there are sections regions for storing blank buffer solution and waste solution respectively in a unified manner.

14. The DNA molecular computation unit with a microfluidic chip of claim 10 wherein on mentioned microfluidic chip, there are sections areas for storing blank buffer solution and waste solution respectively in a unified manner.

15. The DNA molecular computation unit with a microfluidic chip of claim 11 wherein on mentioned microfluidic chip, there are sections regions for storing blank buffer solution and waste solution respectively in a unified manner.

16. The DNA molecular computation unit with a microfluidic chip of claim 12 wherein on mentioned microfluidic chip, there are sections regions for storing blank buffer solution and waste solution respectively in a unified manner.

17. A microfluidic chip DNA molecular storage of mentioned microfluidic chip-based DNA computer of claim 1 comprising storage media, reaction media and the microfluidic chip: mentioned storage media includes the short-chain DNA storage unit molecule with a known sequence, the DNA blank molecule used in initial operation and the DNA storage molecule that represents superposition results through biochemical reactions; mentioned reaction media is the various kinds of biochemical enzymes used in enzyme cleavage and enzyme ligation reactions; mentioned microfluidic chip has at least storage unit area, enzyme cleavage reaction area, enzyme ligation reaction area, and result output area, and carries out the liquid control through the micropump and microvalve with enzyme cleavage reaction area, enzyme ligation reaction area, and result output area connected by microchannels in sequence and storage unit area connected to enzyme ligation reaction area through microchannels.

18. The DNA molecular storage with a microfluidic chip of claim 17 wherein on mentioned microfluidic chip, a PCR amplification region is disposed before the result output section.

19. The DNA molecular storage with a microfluidic chip of claim 17 or 18 wherein on mentioned microfluidic chip, there are sections for storing all kinds of storage media and reaction media, and these sections are connected to each correlative enzyme cleavage reaction area or enzyme ligation reaction area through microchannels

20. The DNA molecular storage with a microfluidic chip of claim 17 or 18 wherein on mentioned microfluidic chip, there are sections regions for storing blank buffer solution and waste solution respectively in a unified manner.

21. The DNA molecular storage with a microfluidic chip of claim 19 wherein on mentioned microfluidic chip, there are sections regions for storing blank buffer solution and waste solution respectively in a unified manner.


SEQUENCE LISTING (4 sequences)

SEQ ID NO: 1 - DNA, 30 bp, Artificial sequence
  Examples to illustrate computation method
atcacgatcacgacggtaacggtaacggta

SEQ ID NO: 2 - DNA, 30 bp, Artificial sequence
  Examples to illustrate computation method
taccgttaccgttaccgtcgtgatcgtgat

SEQ ID NO: 3 - DNA, 50 bp, Artificial sequence
  Examples to illustrate computation method
aggtactaccgttaccgttaccgtcgtgatcgtgatcggatcacacatcc

SEQ ID NO: 4 - DNA, 50 bp, Artificial sequence
  Examples to illustrate computation method
ggatgtgtgatccgatcacgatcacgacggtaacggtaacggtagtacct